(19) United States
(12) Patent Application Publication
(10) Pub. No.: US 2013/0258256 A1
(43) Pub. Date: Oct. 3, 2013

(54) DISPLAY APPARATUS

(71) Applicants: Hoi-Lim KIM, Seoul (KR); Yong-Hwan SHIN, Yongin-si (KR); Min-Sik JUNG, Seoul (KR); Baek-Kyun JEON, Yongin-si (KR)

(72) Inventors: Hoi-Lim KIM, Seoul (KR); Yong-Hwan SHIN, Yongin-si (KR); Min-Sik JUNG, Seoul (KR); Baek-Kyun JEON, Yongin-si (KR)

(73) Assignee: SAMSUNG DISPLAY CO., LTD., Yongin-City (KR)

(21) Appl. No.: 13/605,458

(22) Filed: Sep. 6, 2012

(30) Foreign Application Priority Data
Apr. 3, 2012 (KR) 10-2012-0034543

(51) Int. Cl. G02F 1/1335

(52) U.S. Cl. 349/102

(57) ABSTRACT

A display apparatus according to an exemplary embodiment of the present invention includes first and second polarization plates, first and second phase delay films, and a liquid crystal display panel. A first polarization plate has a first polarization axis. A second polarization plate faces the first polarization plate and has a second polarization axis forming an angle about 85 degrees to 95 degrees with respect to the first polarization axis. A first phase delay film is disposed between the first and second polarization films and has a third polarization axis forming an angle about 40 degrees to 50 degrees with respect to the second polarization plate. A second phase delay film is disposed between the second polarization plate and the first phase delay film, and has a fourth polarization axis forming an angle about −5 degrees to 5 degree with respect to the third polarization axis.

This application claims priority from and the benefit of Korean Patent Application No. 10-2012-0034543, filed on Apr. 3, 2012, which is hereby incorporated by reference for all purposes as if fully set forth herein.

### BACKGROUND

1. Field

Exemplary embodiments of the present invention relate to a display apparatus. More particularly, exemplary embodiments of the present invention relate to a display apparatus having an improved display quality.

2. Discussion of the Background

Generally, a liquid crystal display panel includes a liquid crystal layer interposed between two substrates. The liquid crystal display panel may display a picture using a method of is controlling light transmittance by applying a voltage to the liquid crystal layer. A display apparatus including the liquid crystal display panel and two polarizing plates attached at the liquid crystal display panel may be classified into a normally black mode and a normally white mode, according to whether the display apparatus displays an image at an initial state when an electric field is not applied to the liquid crystal display panel.

A display apparatus may be classified into a vertical electric field mode including a vertical alignment mode (VA mode), and a horizontal electric field mode including an in-plane switching mode (IPS mode) having resolved optical properties according to a direction of liquid crystal molecules when an electric field is applied to a liquid crystal layer. The VA mode or the IPS mode may be used in the normally black mode in order to maximize the contrast ratio of the display apparatus.

However, when a pixel is divided into at least two or more liquid crystal domains in order to improve a viewing angle, such as in a VA mode or IPS mode, the contrast ratio of the display apparatus may decrease. In other words, in a pixel, each of the dispersion of the reflective is different by crystal domains, so that a pass of the light is distorted and a clear image is not displayed. When an electric field is not applied, a normally white mode is applied to display apparatus to display a clear image, however, the contrast ratio of the display apparatus is decreased by the wave length dispersion.

The above information disclosed in this Background section is only for enhancement of understanding of the background of the invention and therefore it may contain information that does not form any part of the prior art nor what the prior art may suggest to a person of ordinary skill in the art.

### SUMMARY OF THE INVENTION

Exemplary embodiments of the present invention provide a display apparatus having improved sharpness and contrast ratio by minimizing wavelength dispersion of transmitted light.

Additional features of the invention will be set forth in the description which follows, and in part will be apparent from the description, or may be learned by practice of the invention.

An exemplary embodiment of the present invention discloses a display apparatus including a liquid crystal display panel, a first polarization plate, a second polarization plate, a first phase delay film, and a second phase delay film. The first polarization plate includes a first polarization axis, the second polarization plate faces the first polarization plate and has a second polarization axis that forms an angle of about 85 degrees to about 95 degrees with respect to the first polarization axis. The first phase delay film is disposed between the first and second polarization plates and has a third polarization axis forming an angle of about 40 degrees to about 50 degrees with respect to the second polarization axis. The second phase delay film is disposed between the second polarization plate and the first delay film and has a fourth polarization axis forming an angle of about −5 degrees to about 5 degrees with respect to the third polarization axis. The liquid crystal display panel is disposed between the first and second phase delay films and has a fifth polarization axis forming an angle of about 80 degrees to about 100 degrees with respect to the fourth polarization axis by an arrangement of liquid crystal molecules of a liquid crystal layer therein when an electric field is applied thereto.

An exemplary embodiment of the present invention also discloses a display apparatus including a liquid crystal display panel, a first polarization plate, a second polarization plate, a first phase delay film, and a second phase delay film. The first polarization plate includes a first polarization axis, the second polarization plate faces the first polarization plate and has a second polarization axis that forms a vertical angle with respect to the first polarization axis. The first phase delay film is disposed between the first and second polarization plates and has a third polarization axis forming an angle of about 45 degrees with respect to the second polarization axis. The second phase delay film is disposed between the second polarization plate and the first delay film and has a fourth polarization axis forming an angle of about −5 degrees to about 5 degrees with respect to the third polarization axis. The liquid crystal display panel is disposed between the first and second phase delay films and has a fifth polarization axis forming a vertical angle with respect to the fourth polarization axis by an arrangement of liquid crystal molecules of a liquid crystal layer therein when an electric field is applied thereto.

An exemplary embodiment of the present invention also discloses a display apparatus including a liquid crystal display element, a first polarizer, a second polarizer, a first phase delay element, and a second phase delay element. The first polarizer includes a first polarization axis, the second polarizer faces the first polarizer and has a second polarization axis that forms an angle of about 90 degrees with respect to the first polarization axis. The first phase delay element is disposed between the first and second polarizers and has a third polarization axis forming an angle of about 45 degrees with respect to the second polarization axis. The second phase delay element is disposed between the second polarizer and the first delay element and has a fourth polarization axis forming an angle of about −0 degrees with respect to the third polarization axis. The liquid crystal display element is disposed between the first and second phase delay elements and has a fifth polarization axis forming an angle of about 90 degrees with respect to the fourth polarization axis when an electric field is applied thereto.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic view illustrating a display apparatus according to an exemplary embodiment of the present invention.

FIG. 2A and FIG. 2B are conceptual views illustrating a method of displaying an image when an electric field is applied and an electric field is not applied to a display apparatus of FIG. 1, respectively.

FIG. 3A, FIG. 3B, and FIG. 3C are Poincare spheres illustrating a change in polarization for a green light according to an exemplary embodiment of the present invention.

FIG. 4A, FIG. 4B, and FIG. 4C are Poincare spheres illustrating a change in polarization for a blue light according to an exemplary embodiment of the present invention.

FIG. 5A, FIG. 5B, and FIG. 5C are Poincare spheres illustrating a change in polarization for a red light according to an exemplary embodiment of the present invention.

FIG. 6A and FIG. 6B are Poincare spheres illustrating a change in polarization according to comparative example.

FIG. 7 illustrates a graph showing a phase delay value with respect to a wavelength of light for a first and second phase delay film.

FIG. 8 is a plane view of a display panel of the display apparatus shown in FIG. 1.

FIG. 9 is a cross-sectional view taken along a line I-I′ of FIG. 8.

FIG. 10 is a plane view illustrating a display panel of a display apparatus according to an exemplary embodiment of the present invention.

FIG. 11 is a cross-sectional view taken along a line II-II′ of FIG. 10.

FIG. 12 is a plane view illustrating a display panel of a display apparatus according to an exemplary embodiment of the present invention.

FIG. 13 is a cross-sectional view taken along a line III-III′ of FIG. 12.

FIG. 14 is a plane view illustrating a display panel of a display apparatus according to an exemplary embodiment of the present invention.

FIG. 15 is a cross-sectional view taken along a line IV-IV′ of FIG. 14.

FIGS. 16A and 16B are images illustrating visibility of display panels according to example embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

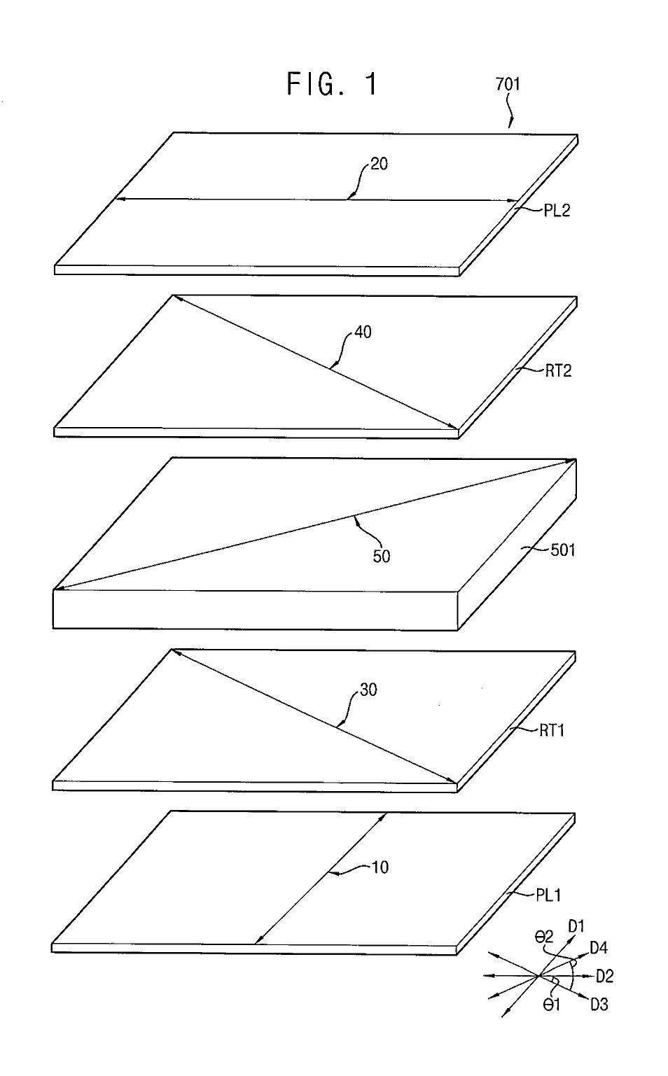

FIG. 1 is a schematic view illustrating a display apparatus according to an exemplary embodiment of the present invention.

Referring to FIG. 1, the display apparatus 701 includes a first polarizing plate PL1, a second polarizing plate PL2, a first phase delay film RT1, a second phase delay film RT2, and a liquid crystal display (LCD) panel 501. A plurality of directions D1, D2, D3, and D4 are illustrated in FIG. 1. However, the present invention may not be limited by the directions shown in FIG. 1.

The first polarization plate PL1 includes a first polarization axis 10 along a first direction D1. When light having a plurality of polarized components is irradiated into the first polarizing plate PL1, other components except linearly polarized light along the first polarization axis 10 is absorbed of reflected, and the linearly polarized light of the first direction D1 passes through the first polarization plate PL1.

The second polarizing plate PL2 is disposed facing the first polarizing plate PL1. The second polarizing plate PL2 includes the second polarization axis 20 along a second direction D2. The second direction D2 may be formed an angle of about 85 degrees to about 95 degrees with respect to the first direction D1. For example, the second direction D2 may be be about 90 degrees with respect to the first direction D1. When light having a plurality of polarized components is irradiated into the second polarizing plate PL2, other components except linearly polarized light along the second polarization axis 20 is absorbed or reflected, and the linearly polarized light of the second direction D2 passes through the second polarization plate PL2. When linearly polarized light of the second direction D2 is radiated through the second polarizing plate PL2, a white image is displayed. Light having other polarized components except the linearly polarized light the second direction D2 is not irradiated through the second polarizing plate PL2, so that a black image is displayed.

The first phase delay film RT1 is disposed between the first and second polarizing plates PL1 and PL2. The first phase delay film RT1 includes the third polarization axis 30 having a different direction, D3, than the first and second polarization axes 10 and 20. The third direction D3 forms a first angle θ₁ with the second direction D2. The first angle θ₁ is an acute angle. The first angle θ₁ is about 40 degrees to 50 degrees. For example, the first angle θ₁ may is be about 45 degrees. The first phase delay film RT1 may include an optical film that delays a phase of light by about λ/4. For example, when a linearly polarized light is irradiated into the first phase delay film RT1, the light passes through the first phase delay film RT1 so that the light changes into a circularly polarized light having a delayed phase of about λ/4. Alternatively, when a circularly polarized light is irradiated into the first phase delay film RT1, the light may be changed into linearly polarized light to pass through the first phase delay film RT1.

The second phase delay film RT2 is disposed between the first phase delay film RT1 and the second polarizing plate PL2. The second phase delay film RT2 includes a fourth polarization axis 40 having a direction, D4, substantially parallel with the third polarization axis 30. The fourth polarization axis 40 may form an angle of about −5 degrees to 5 degrees with respect to the third polarization axis 30. The second phase delay film RT2 may also include an optical film that delays a phase of light by about λ/4.

The liquid crystal display panel 501 is disposed between the first and second phase delay films RT1 and RT2. The LCD panel 501 reflects light passing through the LCD panel 501 when an electric field is applied. However, when the electric field is not applied, the light passing through the LCD panel 501 may not be changed. Thus, the LCD panel 501 has the fifth polarization axis 50 along the fourth direction D4, which is different than the third direction D3 when an electric field is applied. The fifth polarization axis 50 forms an angle about 80 degrees to 100 degrees with respect to the third polarization axis 30. For example, the fourth direction D4 may be perpendicular to the third direction D3. The fifth polarization axis 50 forms an angle with respect to the third or fourth polarization axes 30 and 40 and the angle may be about 80 degrees to 100 degrees. When the angle is greater or less than the range about 80 degrees to 100 degrees, the compensation for a wavelength dispersion of the display apparatus 701 may be decreased. Thus, the angle may be about 90 degrees.

Light passing through the first phase delay film RT1 passes through the LCD panel 501. The phase of the light is not changed when an electric field is not applied. In other words, the difference of a phase delay value between the light passing through the LCD panel 501 and the light passing through the first phase delay film RT1 may be about 0 degrees.

Light passing through the first phase delay film RT1 may next pass through the LCD panel 501. The phase of the light passing through the LCD panel 501 may be changed to an opposite direction when an electric filed is applied to the LCD panel 501. In other words, the light passing through the first phase delay film RT1 may be a circularly polarized light rotating in a clockwise direction. The light passes through the LCD panel 501 when the electric field is applied, and the light may change into a circularly polarized light rotating in a counter-clockwise direction. For example, the LCD panel 501 may have a phase delay value of about λ/2 with respect to the first phase delay film RT1.

The fifth polarization axis 50 of the LCD panel 501 may be inclined by an angle of about 40 degrees to 50 degrees with respect to the first and second polarization axes 10 and 20. The fifth polarization axis 50 may have a direction set by the director of the liquid crystal molecules of the liquid crystal layer. The fifth polarization axis 50 is inclined by a prescribed angle with respect to the first and second polarization axes 10 and 20, so that a viewer may secure a viewing angle.

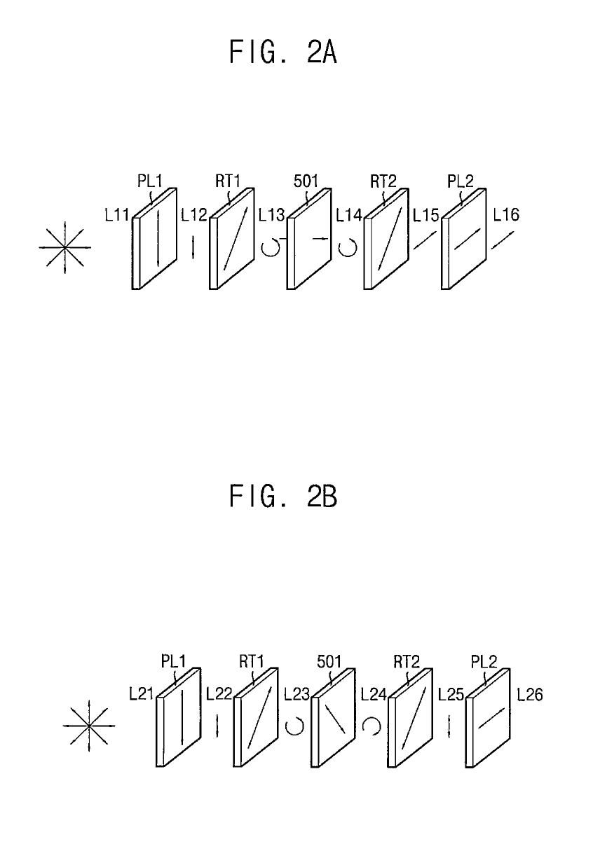

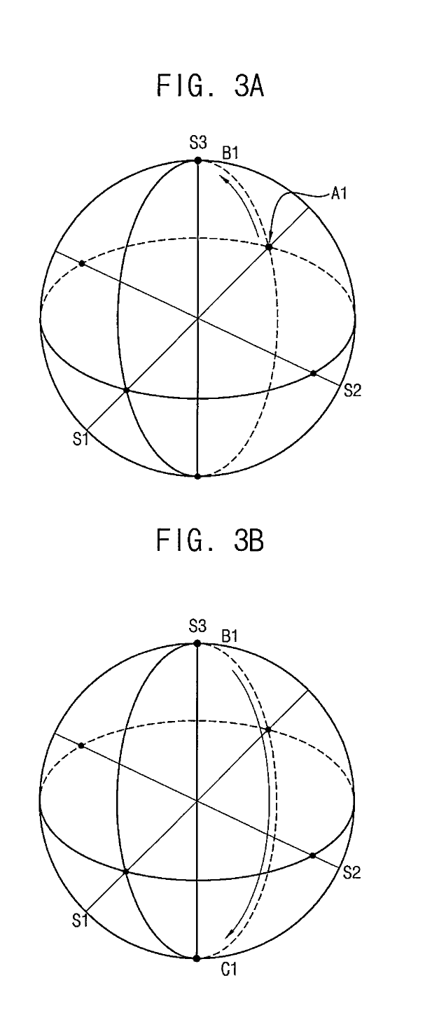

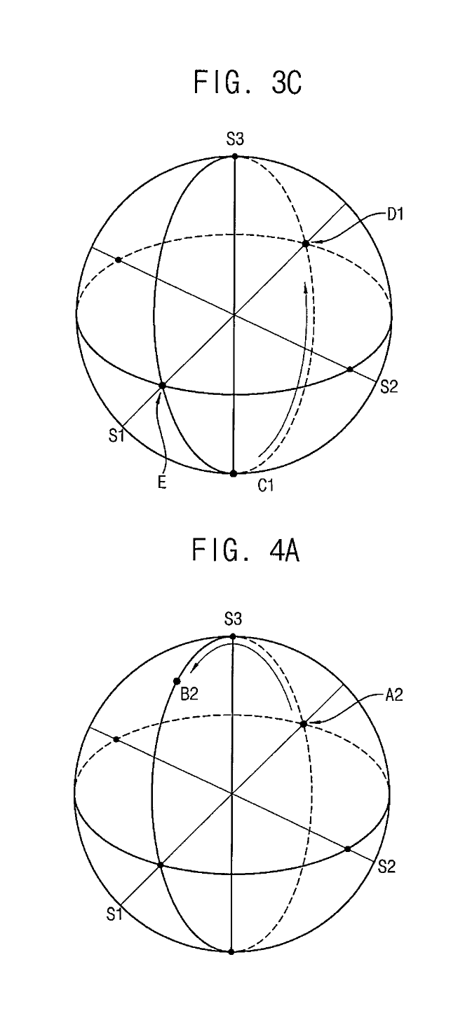

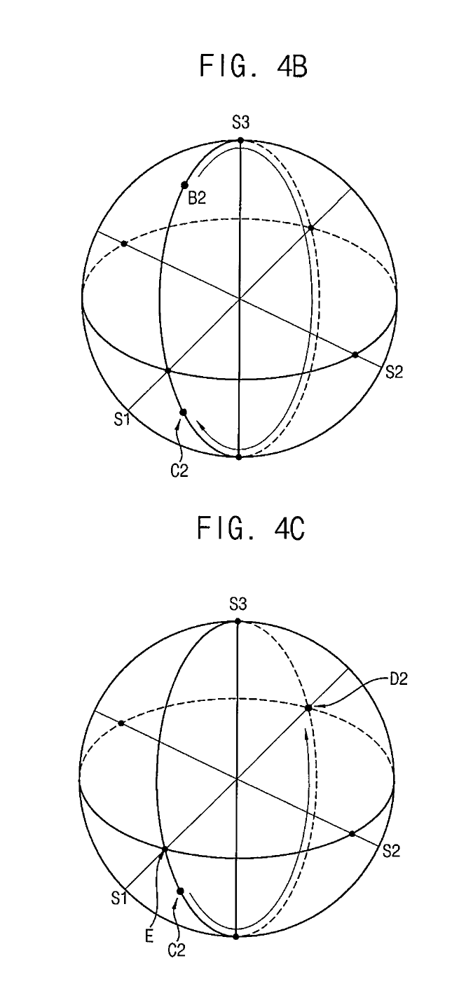

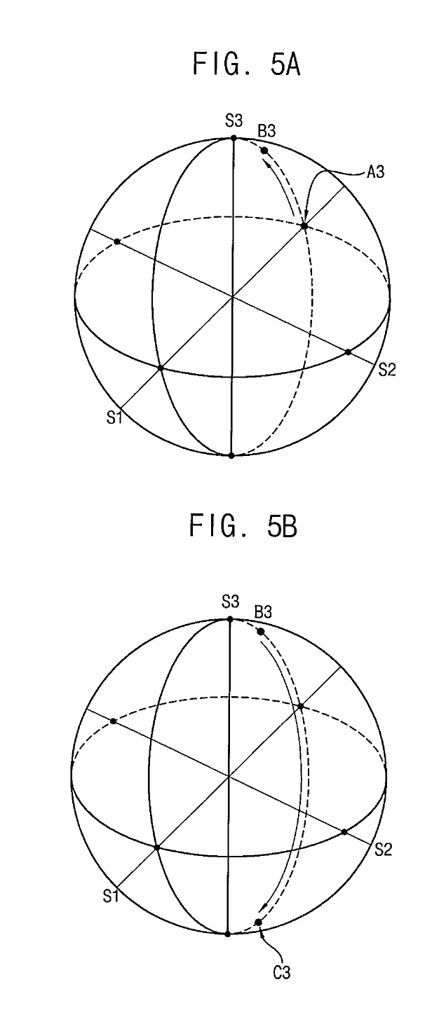

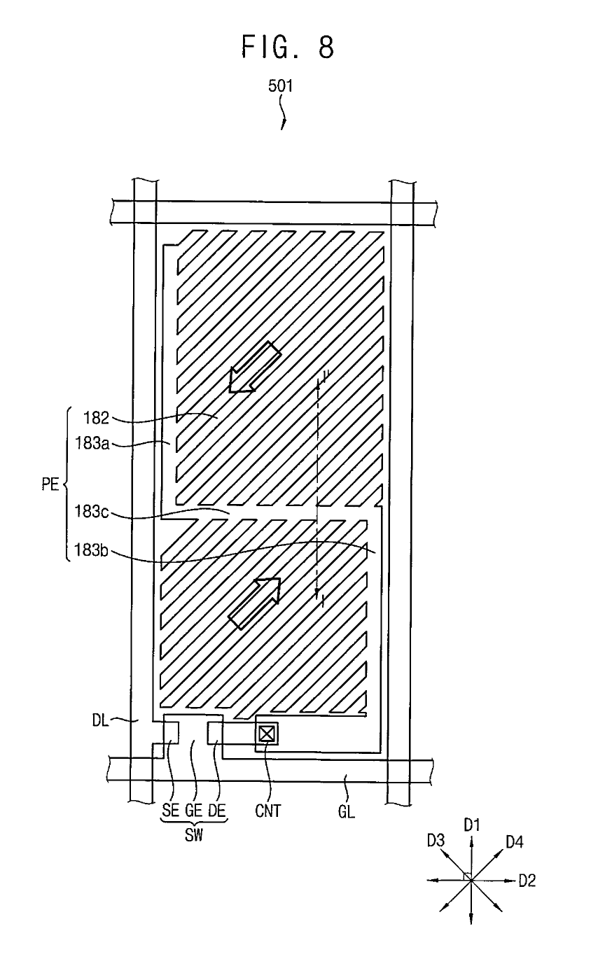

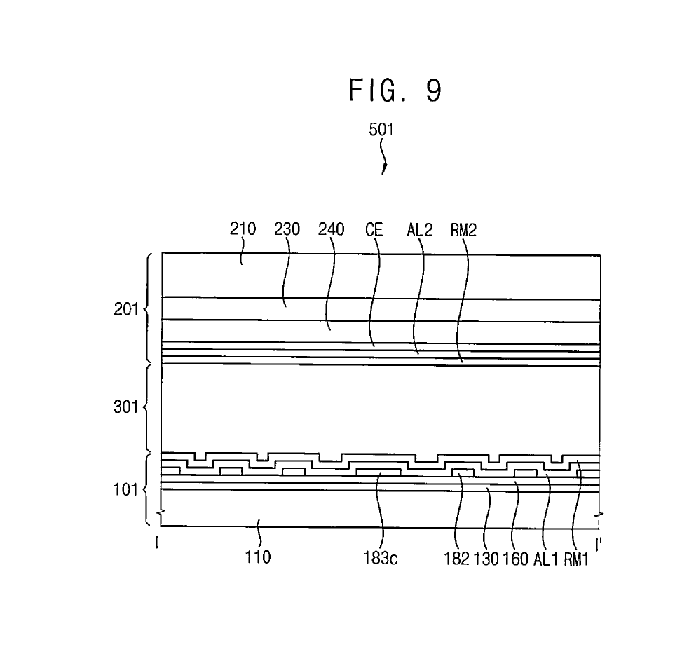

The LCD panel 501 is described with reference to FIG. 8 and FIG. 9. Hereinafter, describing the change in polarization when the electric field is applied or not applied is shown in FIG. 2A and FIG. 2B, and the change in polarization when the electric field is applied is shown in FIG. 3A, FIG. 3B, FIG. 3C, FIG. 4A, FIG. 4B, FIG. 4C, FIG. 5A, FIG. 5B, and FIG. 5C.

FIG. 2A and FIG. 2B are conceptual views illustrating a method of displaying an image when an electric field is respectively applied and not applied to a display apparatus 701 described above with reference to FIG. 1.

The LCD panel 501 shown in FIG. 2A is in a state when the electric field is not applied to the liquid crystal layer 301 referred to in FIG. 9. The LCD panel 501 shown in FIG. 2B is in a state when the electric field is applied to the liquid crystal layer 301.

Referring to FIG. 2A, a first light L11 is irradiated into the first polarization plate PL1. The first light L11 includes a plurality of components. The first light L11 may be a natural light. In other words, the first light L11 may be an external light provided from light sources which are not included in sunlight or the display apparatus 701. On the other hand, the first light L11 may be provided and irradiated from a light supply assembly disposed under the first polarizing plate PL1.

Then the first light L11 is irradiated into the first phase delay plate PL1, a second light L12 of the composition of the first light L11 passes through the first phase delay plate PL1. The second light L12 is a linearly polarized light which has substantially identical direction to the first polarization axis 10. In other words, the first light L11 is changed into the second light L12 to pass through the first polarization plate PL1.

Then the second light L12 is irradiated into the first phase delay film RT1, the second light L12 is changed into a third light L13 to pass through the first phase delay film RT1.

The third light L13 is a circularly polarized light having a delayed phase of about λ/4 with respect to the second light L12. The direction of the circularly polarized light of the third light L13 depends on the third polarization axis 30 of the first phase delay film RT1.

Then the third light L13 is irradiated into the LCD panel 501, the third light L13 is passes through the LCD panel 501 without any effect. The third light L13 is changed into a fourth light L14, however, although the third light L13 substantially identical to the fourth light L14. The fourth light L14 may be a circularly polarized light identical to the circularly polarized direction of the third light L13. The fifth polarization axis 50 does not exist when the electric field is not applied to the LCD panel 501, so that the third light L13 may pass through without any change of the polarization state.

Then the fourth light L14 is irradiated into the second phase delay film RT2, the fourth light L14 is changed into a fifth light L15. The fifth light L15 is a linearly polarized light having a delayed phase of about λ/4 with respect to the fourth light L14. The direction of the linearly polarized light of the fifth light L15 may be perpendicular to the second light L12.

Then the fifth light L15 is irradiated into the second polarization plate PL2. The direction of the second polarization axis 20 of the second polarization plate PL2 is substantially parallel with the direction of the fifth light L15, so that the fifth light L15 passes through the second polarization plate PL2. The fifth light L15 is changed into a sixth light L16, however, although the sixth light L16 is substantially identical to the fifth light L15. Thus, a viewer may cognize the sixth light L16 as a white image.

Referring to FIG. 2B, a first light L21 is irradiated into the first polarization plate PL1. The first light L21 includes a plurality of components which is substantially identical to the first light L11 described in FIG. 2A.

When the first light L21 is irradiated into the first polarization plate PL1, the first polarization plate PL1 polarizes the first light L21, and the first light L21 is changed into a second light L22. The second light L22 is irradiated into the first phase delay film RT1, the first phase delay film RT1 polarizes the second light L22, and the second light L22 is changed into a is third light L23. The second light L22 and the third light L23 is substantially identical to each of the second light L12 and third light L13 described in FIG. 2A. Hereinafter, any repetitive explanation concerning the above elements will be omitted.

When the third light L23 is irradiated into the LCD panel 501, the third light L23 is changed into the fourth light L24. The fourth light L24 is a circularly polarized light rotating in an opposite direction with the direction of the circularly polarized light of the third light L23. In other words, the phase value may have a difference of about λ/2.

When the fourth light L24 is irradiated into the second phase delay film RT2, the fourth light L24 is changed into the fifth light L25. The fifth light L25 is linearly polarized light with a phase change of about λ/4. The direction of the linearly polarized light of the fifth light L25 may be parallel with the second light L22.

The fifth light L25 is irradiated into the second polarization plate PL2. The second polarization axis 20 of the second polarization plate PL2 is substantially perpendicular to the direction of the fifth light L25, so that the fifth light L25 is absorbed into the second polarization plate PL2, reflected by the second polarization plate PL2, or both absorbed and reflected. Thus, the viewer may cognize a black image. In other words, the sixth light L26 passing through the second polarization plate PL2 substantially does not exist.

The direction of the linearly and circularly polarized lights described in FIG. 2A and FIG. 2B is a relative direction, so the direction of the linearly and circularly polarized light is not limited to the direction described in FIG. 2A and FIG. 2B. For example, the second light L12 described in FIG. 2A may be not linearly polarized light having a longitudinal direction, but a linearly polarized light having a transverse direction. The third light L13 may be not circularly polarized light having a counter-clockwise direction, but a circularly polarized light having a is clockwise direction. In other words, light passes through passes through the first and second phase delay films RT1, RT2, the LCD panel 501, and the second polarization plate PL2 according to the direction of the linearly polarized light of the second lights L12, L22 described in FIG. 2A and FIG. 2B. The polarization state of the light may be applied to various cases along the direction of the first and second phase delay films RT1, RT2, LCD panel 501, and each of the second, third, fourth, or fifth polarizing axes 20, 30, 40, and 50.

As described above, the display apparatus 701 displays a white image when an electric field is not applied to the LCD panel 501 (i.e., the display apparatus 701 is in a “normally white mode”), but the normally white mode displays a black image when an electric field is applied. Even though the liquid crystal layer of the LCD panel 501 may be designed to include a plurality of liquid crystal domains, a non-uniformity problem of refractivity by the liquid crystal domains may be solved, because the liquid crystal domains are not generated at the non-electric field state displaying the normally white mode. Thus, visibility of the white image may be improved.

Also, when the electric field is applied to the liquid crystal layer, the direction of the linearly polarized light of the fifth light L25 passing through the second phase delay film RT2 may be compensated to have an almost vertical angle with respect to the second polarization axis 20 of the second polarizing plate PL2. Compensation may depend on the relation of the arrangement of the first and second phase delay films RT1 and RT2 and the LCD panel 501, and the black brightness may be minimized thereby. Thus, contrast ratio of the display apparatus 701 may be improved. Compensation of the direction of the linearly polarized light of the fifth light L25 is described with reference to FIG. 3B, FIG. 3C, FIG. 4A, FIG. 4C, FIG. 5A, and FIG. 5C.

In exemplary embodiments where the first lights L11 and L21 are irradiated from a single light source, a diode package may be used. The diode package irradiates white light including at least three diodes emitting a red light, a green light, and blue light as a light source. The first lights L11 and L21 are created from each of the diodes. Each of the first lights L11 and L12 may have different wavelengths and phase values, so that some of the light of the first lights L11 and L21 passing through the second polarization plate PL2 when the electric field is applied may minimize the black brightness. According to the relation of the arrangement of the LCD panel 501 and the first and second phase delay films RT1 and RT2, the polarizing state of the fifth light L15 and L25 may be compensated properly. Thus, even though the diode package is used, the black brightness may be minimized.

The first lights L11 and L21 may be natural lights. The display apparatus 701 may be used as a transparent display. An object may be disposed on a first side of the first polarization plate PL1. The object may be seen through the transparent display at a second side of the second polarizing plate PL2, opposite to the first side of the first polarization plate PL1. In other words, an image of the object passes through the display apparatus 701 and may be applied to the viewer. The image passes through the display apparatus 701 without light reflection when the electric field is not applied, in the normally white mode, thus image distortion may be prevented and the viewer may cognize the image clearly. According to the relation of the arrangement of the LCD panel 501 and the first and second phase delay films RT1 and RT2, the polarizing state of the fifth light L15 and L25 may be compensated properly, wavelength dispersion of the natural light may be minimized, and the black brightness may be minimized.

Hereinafter, the change of the polarization at electric field state described with respect to the exemplary embodiment shown in FIG. 2B and compensation of the polarization is state are described stereoscopically with reference to FIG. 3A, FIG. 3B FIG. 3C, FIG. 4A, FIG. 4B, FIG. 4C, FIG. 5A, FIG. 5B, and FIG. 5C by using the Poincare sphere. The Poincare sphere described in these figures includes three coordinate axes, a first axis S1, a second axis S2, and a third axis S3. Each end portion of a first coordinate axis S1 represents two linearly polarized lights that each form a vertical angle. Each end portion of the second coordinate axis S2 represent two linearly polarized lights that each form a vertical angle along the direction which is the between the first and second linearly polarized lights. The linearly polarized lights which are represented by each end portion of the second coordinate axis S2 may form an angle about 45 degrees with respect to the linearly polarized lights which are represented by each end portion of the first coordination axis S1. Each end portion of the third coordinate axis S3 represents two circularly polarized lights rotating in opposite directions.

FIG. 3A, FIG. 3B, and FIG. 3C are Poincare spheres for describing the change in polarization of a green light.

Referring to FIG. 3A and FIG. 2B, the green light, for example, a light that has about a 550 nm wavelength, passes through the first polarization plate PL1. The second light L22 passing through the first polarization plate PL1 may be disposed on a first aspect A1 of the first coordination axis S1.

At a second aspect facing the first aspect A1 of the first coordination axis S1, a linearly polarized light is disposed that is perpendicular with the second light L22. The extinction point of the Poincare sphere represents a position of the ideal polarization state of the light passing from the first polarization plate PL1 to second phase delay film RT2. The first aspect A1 of the first coordination axis S1 is the extinction point. In other words, the polarization state of the fifth light L25 passing through the second phase delay film RT2 is is substantially identical to the polarization state of the first aspect A1 of the first coordination axis S1, so that the fifth light L25 may entirely be absorbed by the second polarization plate PL2.

The second light L22 passes through the first phase delay film RT1. The first phase delay film RT1 polarizes the second light L22, so that the second light L22 is changed into the third light L23 which is a circularly polarized light. The third light L23 is disposed on a first aspect B1 of the third coordinate axis S3. The third polarization axis 30 of the first phase delay film RT1 is substantially identical to the first rotation axis of the second coordination axis S2. The first rotation axis may rotate in the counter-clockwise direction. Thus, the second light L22 of the first aspect A1 of the first coordination axis S1 may has a polarization state varied along the first rotation axis of the second coordination axis S2. The third light L23 may be disposed on the first aspect B1 of the third coordination axis S3.

Referring to FIG. 3B, the third light L23 passes through the LCD panel 501. The LCD panel 501 polarizes the third light L23, so that the third light L23 is changed into the fourth light L24 and the fourth light L24 is disposed on a second aspect C1 of the third coordination axis S3. The fifth polarization axis 50 of the LCD panel 501 substantially identical to the second rotation axis of the second coordination axis S2. The second rotation axis of the second coordination axis S2 may rotate to a counter-clockwise direction which is an opposite direction with the first rotation axis of the first phase delay film FT1. Thus, the third light L23 of the first aspect B1 of the third coordination axis S3 may have a polarization state varied along the second rotation axis of the second coordination axis S2. The fourth light L24 may be disposed on the second aspect C1 of the third coordination axis S3.

Referring to FIG. 3C, the fourth light L24 passes through the second phase delay film RT2. The second phase delay film RT2 polarizes the fourth light L24, so that the fourth is light L24 is changed into the fifth light L25. The fifth light L25 is disposed on a point D1 which is substantially identical to the first aspect A1 of the first coordinate S1. The fourth polarization axis 40 of the second phase delay film RT2 is substantially identical to the first rotation axis of the second coordination axis S2. The point D1 of the first coordination axis S1 described in FIG. 3C is substantially identical to the first aspect A1 of the first coordination axis S1, which is where the second light L22 described in FIG. 3A is disposed on. Thus, the fifth light L25 is disposed on the extinction point of the Poincare sphere.

In other words, the first light L21 which is the green light passes through the first polarizing plate PL1, the first phase delay film RT1, the LCD panel 501, and the second delay film RT2 in sequence, so that the first light L21 may be polarized. The first light L21 may be changed into the fifth light L25. Thus, the fifth light L25 may be absorbed by the second polarization plate PL2.

According to FIG. 3A, FIG. 3B, and FIG. 3C, the first light L21 is a green light, the change of the polarization is disposed on the end portions of the first coordination axis S1, and the change of the polarization is identical to each end portion of the first coordination axis S1. The fifth light L25 is disposed on the extinction point, finally.

FIG. 4A, FIG. 4B, and FIG. 4C are Poincare spheres for describing the change in polarization of a blue light.

Referring to FIG. 4A with respect to the exemplary embodiment shown in FIG. 2B, the blue light, for example, a light which has about a 550 nm wavelength passes through the first polarization plate PL1. The second light L22 passing through the first polarization plate PL1 may be disposed on a first aspect A2 of the first coordination axis S1.

The second light L22 passes through the first phase delay film RT1. The first is phase delay film RT1 polarizes the second light L22, so that the second light L22 is changed into the third light L23, which is a circularly polarized light, by passing through the first phase delay film RT1. However, the third light L23 has greater rotation to the first rotation axis of the second coordination axis S2 than the green light described in FIG. 3A. Thus, the second light L22 of the blue light is disposed on a first point B2 which is the counter-clockwise direction point of the first aspect B1 of the third coordination axis S3 described in FIG. 3A.

Referring to FIG. 4B, the second light L22 which disposed on the first point B2 passes through the LCD panel 501, so that the second light L22 is changed into the fourth light L24. The fourth light L24 rotates to the second rotation axis of the second coordination axis S2 more than the green light as described in FIG. 3A by the space of a part from the first aspect A1 of the third coordination axis S3 to the first point B2. Thus, the fourth light L24 of the blue light may be disposed on the second point C2 which is in a clockwise direction point of the second aspect C1 of the third coordination axis S3 described in FIG. 3A.

Referring to FIG. 4C, the fourth light L24 passes through the second phase delay film RT2, so that the fourth light L24 is changed into the fifth light L25. The fifth light L25 is disposed on a point D2 which is substantially identical to the first aspect A2 of the first coordination axis S1. The point D2 of the first coordination axis S1 described in FIG. 4C is substantially identical to the first aspect A2 of the first coordination axis S1, which is the second light L22 described in FIG. 4A. Thus, the fifth light L25 is disposed on the extinction point of the Poincare sphere.

Even though the polarization state of the first light L21, which is the blue light, strays from the first aspect B1 of the third coordination axis S3 described in FIG. 3B by passing through the first phase delay film RT1, the first light L21 is polarized to the fifth light L25, is which is disposed on the point D2 that is substantially identical to the extinction point, by compensating while the blue light passes through the LCD panel 501 and the second delay film RT2 in sequence. In other words, the blue light passes through the first phase delay film RT1, so that the light moves more along the first rotation axis. However, the polarization state of the blue light is compensated by the LCD panel 501 and the second phase delay film RT2, which moves more along the second rotation axis. Thus, the fifth light L25 may be absorbed by the second polarization plate PL2.

The first light L21 is a blue light, described in FIG. 4A, FIG. 4B, and FIG. 4C, and the change in polarization is advanced differently than the change in polarization of the green light described above, but the fifth light L25 passing through the second phase delay RT2 may be disposed on the identical or similar point to the extinction point as with respect to the green light.

FIG. 5A, FIG. 5B, and FIG. 5C are Poincare spheres for describing the change in polarization of a red light.

Referring to FIG. 5A with respect to the exemplary embodiment shown in FIG. 2B, the red light, for example, a light which has about a 630 nm wavelength passes through the first polarization plate PL1. The second light L22 passing through the first polarization plate PL1 may be disposed on a first aspect A3 of the first coordination axis S1.

The second light L22 passes through the first phase delay film RT1, and the first phase delay film RT1 polarizes the second light L22. The second light L22 is changed into the third light 23, which is a circularly polarized light. However, the third light L23 rotates less to the first rotation axis of the second coordination axis S2 than the green light described in FIG. 3A. Thus, the second light L22 of the red light is disposed on a first point B3 which is the is clockwise direction point of the first aspect B1 of the third coordination axis S3 described in FIG. 3A.

Referring to FIG. 5B, the second light L22, which disposed on the first point B2, passes through the LCD panel 501, and the second light L22 is changed into the fourth light L24. The fourth light L24 rotates to the second rotation axis of the second coordination axis S2 less than rotation of the green light described in FIG. 3A by the space of a part from the first aspect B1 of the third coordination axis S3 to the first point B2. Thus, the fourth light L24 of the red light may be disposed on the second point C3 which is in a counter-clockwise direction point of the second aspect C1 of the third coordination axis S3 described in FIG. 3A.

Referring to FIG. 5C, the fourth light L24 passes through the second phase delay film RT2, and the second phase delay film RT2 polarizes the fourth light L24. The fourth light L24 is changed into the fifth light L25, and the fifth light L25 is disposed on a point D3 which is substantially identical to the first aspect A3 of the first coordination axis S1. The point D3 of the first coordination axis S1 described in FIG. 5C is substantially identical to the first aspect A3 of the first coordination axis S1, which is the second light L22 described in FIG. 5A disposed on. Thus, the fifth light L25 is disposed on the extinction point of the Poincare sphere.

Even though the polarization state of the first light L21, which is the red light, strays from the first aspect B1 of the third coordination axis S3 described in FIG. 3B by passing through the first phase delay film RT1, the first light L21 is polarized to the fifth light L25, which is disposed on the point D3 that is substantially identical to the extinction point, by compensating while the red light passes through the LCD panel 501 and the second delay film RT2 in sequence. In other words, the red light passes through the first phase delay film RT1, so that the light moves less along the first rotation axis. However the polarization state of the red is light is compensated by the LCD panel 501 and the second phase delay film RT2, which moves less along the second rotation axis. Thus, the fifth light L25 may be absorbed by the second polarization plate PL2.

The first light L21 is a red light, described in FIG. 5A, FIG. 5B, and FIG. 5C, and the change in polarization is advanced differently than the change in polarization of the green light described above, but the fifth light L25 passing through the second phase delay RT2 may be disposed on the identical or similar point to the extinction point as with respect to the green light.

According to the exemplary embodiment shown in FIG. 3A, FIG. 3B, FIG. 3C, FIG. 4A, FIG. 4B, FIG. 4C, FIG. 5A, FIG. 5B, and FIG. 5C, each of the green, blue, and red lights pass through the first polarization plate PL1, the first phase delay film RT1, the LCD panel 501, and the second phase delay film RT2, in sequence. Each of the polarization states of the green, blue, and red lights may be substantially identical to an extinction point at the Poincare sphere. Also, the second polarization axis 20 of the second polarization plate PL2 may be substantially identical to the direction of the polarization axis of the opposite side of the extinction point. Thus, the contrast ratio of the black image may be maximized by minimizing the wavelength dispersion of the green, blue, and red lights.

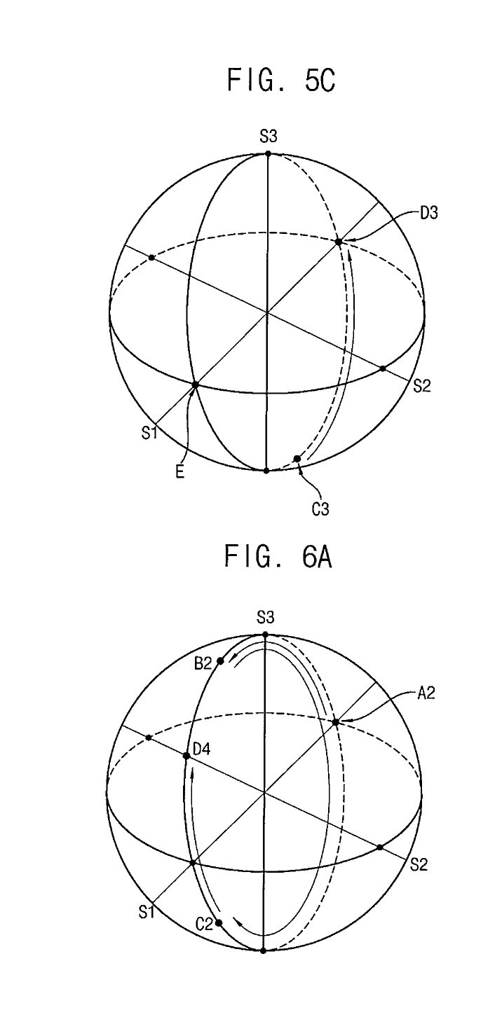

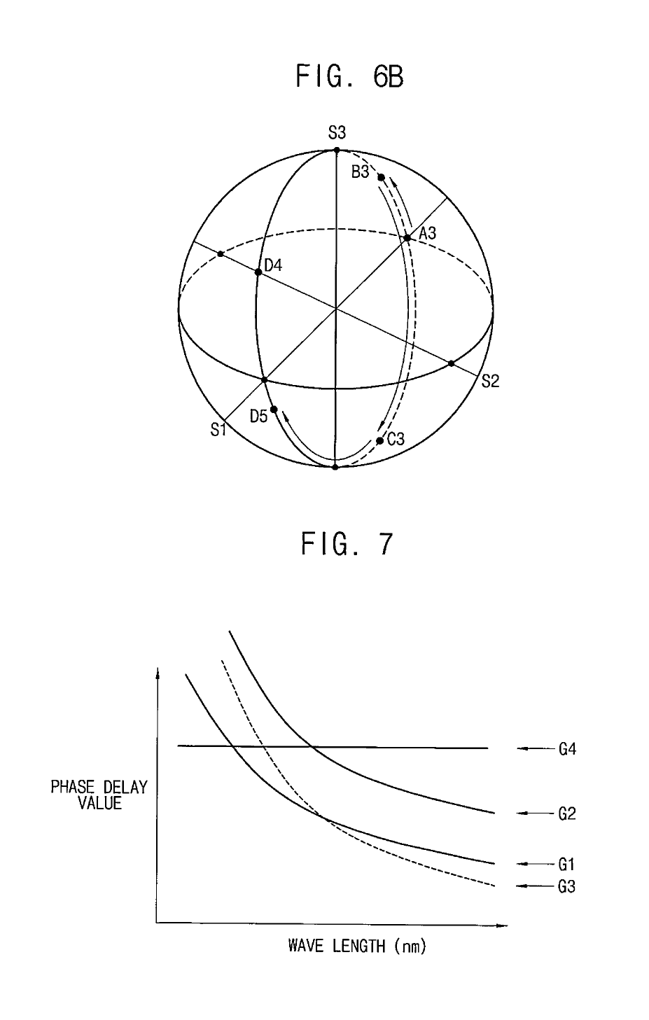

FIG. 6A and FIG. 6B describe the reason for the occurrence of wavelength dispersion in an example comparison between the display apparatus 701 described in FIG. 1, FIG. 2A, and FIG. 2B with another display apparatus. The display apparatus has two polarizing plates having parallel polarizing axes, two λ/4 phase delay films disposed between the polarizing plates and having polarizing axes forming an angle about 45 degrees with respect to the polarizing plates and a LCD panel configured to transmit a light when the electric field is not applied.

FIG. 6A and FIG. 6B are Poincare spheres illustrating the change in polarization according to the example comparison. FIG. 6A is a Poincare sphere for describing the change in polarization of a blue light, and FIG. 6B is a Poincare sphere for describing the change in polarization of a red light. The extinction point in FIG. 6A is a point along the second coordination axis S2 being disposed on an opposite side of the point A2, and the extinction point in FIG. 6B is a point along the second coordination axis S2 being disposed on an opposite side of the point A3.

The first light L21 is the green light, in a display apparatus according to the example comparison, which passes through the first λ/4 phase delay film, the LCD panel and the second λ/4 phase delay film, in sequence, so that the first light L21 passing through the second λ/4 phase delay film may be disposed on the extinction point on a Poincare sphere.

Referring to the FIG. 6A, the first light L21 is the blue light, in a display apparatus according to the example comparison, in which a light passes through the first λ/4 phase delay film, the LCD panel, and the second λ/4 phase delay film, in sequence, so that the polarization state of the first light L21 reaches the point D4 from a point A2 via points B2 and C2 on the Poincare sphere. In other words, the point B2 is disposed outside of the first aspect B1 of the third coordination axis S3 in the counter-clockwise direction as shown in FIG. 3A, and is disposed on the point D4 rotated in a clockwise direction by the second λ/4 phase delay film. Thus, the point D4 may be disposed after the extinction point in the clockwise direction.

Referring to FIG. 6B, the first light L21 is the red light, in a display apparatus according to the example comparison, in which a light passes through the first λ/4 phase delay film, the LCD panel, and the second λ/4 phase delay film, in sequence, so that the polarization state of the first light L21 reaches the point D5 from a point A3 via points B3 and C3 on the Poincare sphere. In other words, the point B3 is disposed outside of the first aspect B1 of the third coordination axis S3 in the clockwise direction as shown in FIG. 3A, and is disposed on the point D5 rotated in a clockwise direction by the second λ/4 phase delay film. Thus, the point D4 may be disposed before the extinction point in the clockwise direction.

According to the comparison example described in FIG. 6A and FIG. 6B, using a diode package or a transparent display in a display apparatus, the visibility of an image may be improved by modulating the LCD panel to transmit light without any change when an electric field is not applied. However, the wavelength dispersion may be generated by the red and the blue light, so that the black brightness is increased.

When comparing a display apparatus according to an exemplary embodiment of the present invention, such as in the display apparatus 701, with a display apparatus according to the comparison example, the visibility and contrast ratio of the display apparatus may be improved by arranging the first and second polarization plates PL1, PL2, the first and second phase delay films RT1, RT2, and the LCD panel 501.

For compensating the path that passes before or after the extinction point along the first rotation axis, by passing the first phase delay film RT1 as passing through the LCD panel 501 and the second phase delay film RT2, the ratio of a phase delay value Δnd₁ of the liquid crystal layer to a sum of a phase delay value Rₒ of each surface of the first and second phase delay film RT1, RT2 may be constant. In other words, a sum of Rₒ/Δnd may be a constant. When the reflectivity of each of an x-axis and a y-axis that define a plane are allowed to a vertical angle represented as nₓ and n_{y}, Rₒ is represented as “(nₓ−n_{y})*d₂”, and “d₂” represents the thickness of the first and second phase delay films RT1 and RT2.

FIG. 7 is a graph showing a phase delay value with respect to a wavelength of is first and second phase delay films according to an exemplary embodiment of the present invention.

Line G1 in FIG. 7 represents a phase delay value on a surface of the liquid crystal layer according to a transmitted light wavelength, and each of lines G2, G3, and G4 represent a phase delay value on a surface of a phase delay film.

Comparing lines G1 with G3, while a phase delay value of a phase delay film is higher than a phase delay value of the liquid crystal layer in a lower wavelength region, the phase delay value of the liquid crystal layer is higher than the phase delay value of the phase delay film in higher wavelength region. Thus, a light that the liquid crystal layer and the phase delay films polarize passes through the extinction point on a Poincare sphere when a transmitted light wavelength is high, and the light reaches behind the extinction point on a Poincare sphere when a transmitted light wavelength is low. In other words, when using a phase delay film which has a property of the line G3 according to the present exemplary embodiment, the compensation of the polarization state may decrease as the wavelength of transmitted light increases.

Also, using a phase delay film which has a phase delay value in a lower wavelength region, the phase delay value may be a lower value than the phase value of the liquid crystal layer. However, the phase delay value may be a higher value than the phase value of the liquid crystal layer in a higher wavelength region, so the compensation level of the polarization state may be low.

However, comparing line G1 and line G2, line G2 has a ratio being constant with respect to the wavelength range in line G1. Also, the phase delay value is higher than the phase value of the liquid crystal layer in a lower wavelength region. However, the phase delay value is is also higher than the phase delay value of the liquid crystal layer in a higher wavelength region. The line G1 and line G2 have substantially similar properties, so that the second phase delay film RT2 may compensate polarization of light passing through the first phase delay film RT1 and liquid crystal display panel 501 appropriately. Thus, the contrast ratio may be maximized.

For the above-described exemplary embodiment, a liquid crystal optical film may be used as the first and second phase delay films RT1, RT2. The liquid crystal optical film may have a constant ratio with respect to the phase delay value of the liquid crystal layer in any range of the wavelength.

Hereinafter, the liquid crystal display panel shown in FIG. 1, FIG. 2A, and FIG. 2B is described in detail referring to FIG. 8 and FIG. 9. Transmitted light passes through the LCD panel 501 without any change when an electric field is not applied to a liquid crystal layer 301. However, the liquid crystal layer 301 polarizes the light when an electric field is applied to the liquid crystal layer 301.

FIG. 8 is a plane view of a LCD panel 501 of the display apparatus 701 of FIG. 1, and FIG. 9 is a cross-sectional view taken along a line I-I′ of FIG. 8.

Referring to FIG. 8 and FIG. 9, with respect to the exemplary embodiment shown in FIG. 1, the LCD panel 501 includes a TFT substrate 101, an opposite substrate 201, and the liquid crystal layer 301.

A first phase delay film RT1 is disposed under the TFT substrate 101, and a first polarization plate PL1 is disposed under the phase delay film RT1. Also, a second phase delay film RT2 is disposed on the opposite substrate 201, and the second polarization plate PL2 is disposed on the second phase delay RT2.

The TFT substrate 101 includes a gate line GL, a data line DL, a thin film is transistor SW, a pixel electrode PE, a first alignment film AL1, and a first mesogen hardening layer RM1.

The data line DL may be extended along the first direction D1, and the gate line GL may extended along the second direction D2. The thin film transistor SW is connected with the data line DL, the gate line GL, and the pixel electrode PE. The thin film transistor SW includes a gate electrode GE connected with the gate line GL, a source electrode SE connected with the data line DL, a drain electrode DE spaced apart from the source electrode SE, and an active pattern (not shown).

The gate line GL and the data line DL are insulated by a gate insulating layer 130, and the TFT is covered by a passivation layer 160. The drain electrode DE of the thin film transistor SW is partially exposed through the contact hole CNT of the passivation layer 160, and the thin film transistor SW is connected with the pixel electrode PE through the contact hole CNT. For example, the pixel electrode PE may be disposed in a corresponding area that is formed by the intersection of the gate line GL and the data line DL. The pixel electrode PE is connected with the drain electrode DE through the contact hole CNT.

The pixel electrodes PE may include a plurality of slit patterns 182. The slit patterns 182 may extend in a third direction D3 parallel with the polarization axis of the first and second phase delay films RT1 and RT2, and a fourth direction D4 perpendicular with the polarization axis of the first and second phase delay films RT1 and RT2. Also, the third direction D3 and fourth direction D4 are disposed between a first direction D1 that is extended along the data line DL and a second direction D2 that is extended along the gate line GL.

The pixel electrode PE includes a first connection pattern 183a and a second connection pattern 183b that are extended along the first direction D1, and a third connection is pattern 183c extended along the second direction D2. For example, the first connection pattern 183a is disposed beyond the data line DL connected with the source electrode SE of the thin film transistor SW, so that connection pattern 183a connects each of a first part of the portion of the slit patterns 182, and the second connection pattern 183b is disposed under the opposite side of the first connection pattern 183a, so that the second connection pattern 183b connects each of a second part of the portion of the slit patterns 182. Each slit pattern 182 may be connected by the first connection pattern 183a, but not connected by the second pattern 183b. The third connection pattern 183c crosses the pixel PE and is extended along the second direction D2, and the third connection patterns 183c connects the first and second patterns 183a, 183b each other. In other words, viewed on a plane with respect to the third connection pattern 183b, the first connection pattern 183a is connected with a first part of the third connection pattern 183c, and the second connection pattern 183b is connected with a second part opposite to the first part of the third connection pattern 183c, the second connection pattern 183b extending in an opposite direction to the first connection pattern 183a.

The first alignment film AL1 is formed on the pixel electrode PE. The first alignment film AL1 may be a vertical alignment film which aligns the liquid crystal molecules in a homeotropic vertical direction with respect to the surface of the first base substrate 110 at the initial state of the liquid crystal molecules. The first alignment film AL1 may align the liquid crystal molecules in a homeotropic vertical direction with a second alignment film AL2 of the opposite substrate 201 between the TFT substrate 101 and the opposite substrate 201.

The first mesogen hardening layer RM1 being disposed on the first alignment film AL1 is disposed between the first alignment film AL1 and the liquid crystal layer 301. The first mesogen hardening layer RM1 aligns the liquid crystal molecules to have a pretilt angle which is is from about 87 degrees to 90 degrees. The response time of the liquid crystal molecules may be improved by the first mesogen hardening layer RM1.

The opposite substrate 201 facing the TFT substrate 101 is disposed between the TFT substrate 101 and the second phase delay film RT2. The opposite substrate 201 includes a shielding pattern (not shown) formed on a second base substrate 210, a color filter 230, an over coating layer 240, a common electrode CE, a second alignment layer AL2, and a second mesogen hardening layer RM2. At least one of the shielding pattern 220 and the color filter 230 may be formed on the first base substrate 110, and the over coating layer 240 may be omitted.

The common electrode CE may entirely cover the opposite substrate 201. The common electrode CE may be formed corresponding to the entire area of the second base substrate 201, and the common electrode CE may form a vertical electric field with the silt patterns 182 of the pixel electrode PE.

The second alignment layer AL2 is formed on the common electrode CE, and the second mesogen hardening layer RM2 is formed on the second alignment film AL2. The second alignment film AL2 is substantially identical to the first alignment film AL1, and the second mesogen hardening layer RM2 is substantially identical to the first mosogen hardening layer RM1. Thus, any repetitive explanation concerning the above elements will be omitted. The second alignment film AL2 aligns the liquid crystal molecules in homeotropic vertical direction when the electric field is not applied, and the liquid crystal molecules may have a pretilt angle by the second mesogen hardening layer RM2.

The liquid crystal layer 301 includes the liquid crystal molecules, and the liquid crystal molecules are aligned in homeotropic vertical direction with respect to the surfaces of first and second base substrates 110, 210. The alignment of the liquid crystal molecules in the homeotropic vertical direction represents that the liquid crystal molecules are aligned about 87 degrees to 90 degrees.

The liquid crystal molecules are aligned in homeotropic vertical direction when the electric field is not applied, so that the third light L13 irradiated into the LCD panel 501 passes through the first phase delay film RT1 as described in FIG. 2A and passes through the LCD panel 501, the second phase delay film RT2, and the second polarization plate PL2. Thus, a viewer may cognize a white image.

Also, the liquid crystal molecules may be aligned as being inclined to the fourth direction D4 which extends in the direction of the silt patterns 182. A direction of the arrow illustrating in FIG. 8 represents a direction of the director of the liquid crystal molecules when the electric field is applied to the liquid crystal layer.

A light may pass through the LCD panel 501 without any effect when the electric field is not applied, however, the LCD panel 501 may polarize the light when the electric field is applied. Thus, the LCD panel 501 may be used in the normally white mode display apparatus 701 including the first and second polarization plates PL1 and PL2, the first and second phase delay films RT1 and RT2, and the LCD panel 501. The visibility and contrast ratio of the display apparatus 701 thus may be improved.

A method for manufacturing the LCD panel 501 referring to FIG. 9 is described below. The gate line GL, the data line DS, the thin film transistor SW, the pixel electrode PE, and the first alignment film AL1 are formed on the first base substrate 110.

The shielding pattern, the color filter 230, the over coating layer 240, the common electrode CE, and the second alignment film AL2 are formed on the second base substrate 210.

A liquid crystal composition including the liquid crystal molecules and a reactive mesogen may be disposed between the first base substrate 110 having the first alignment film AL1 and the second base substrate 210 having the second alignment film AL2.

The electric filed is applied to the pixel electrode PE and the common electrode CE, so that the director of the liquid crystal molecules is aligned as being inclined in the fourth direction D4. The alignment angle may be an acute angle. The angle may be from about 87 degrees to 90 degrees. The transmitted light is irradiated into the liquid crystal composition when the electric filed is applied. In other words, the light may be irradiated into the liquid crystal composition from outside of the first base substrate 110 or the second base substrate 201. The reactive mesogen is polymerized by the light, so that the second mesogen hardening layer RM2 is formed on the second alignment film AL2.

When the electric filed is not applied, after forming the first and second mesogen hardening layers RM1 and RM2, the LCD panel 501 may be manufactured as illustrated in FIG. 8 and FIG. 9.

The LCD panel 501 is modulated as a light passes through when the electric filed is not applied, and the first and second polarization plates PL1 and PL2, and the first and second phase delay films RT1 and RT2 are used as described in FIG. 1, so that the visibility and contrast ratio of an image may be improved.

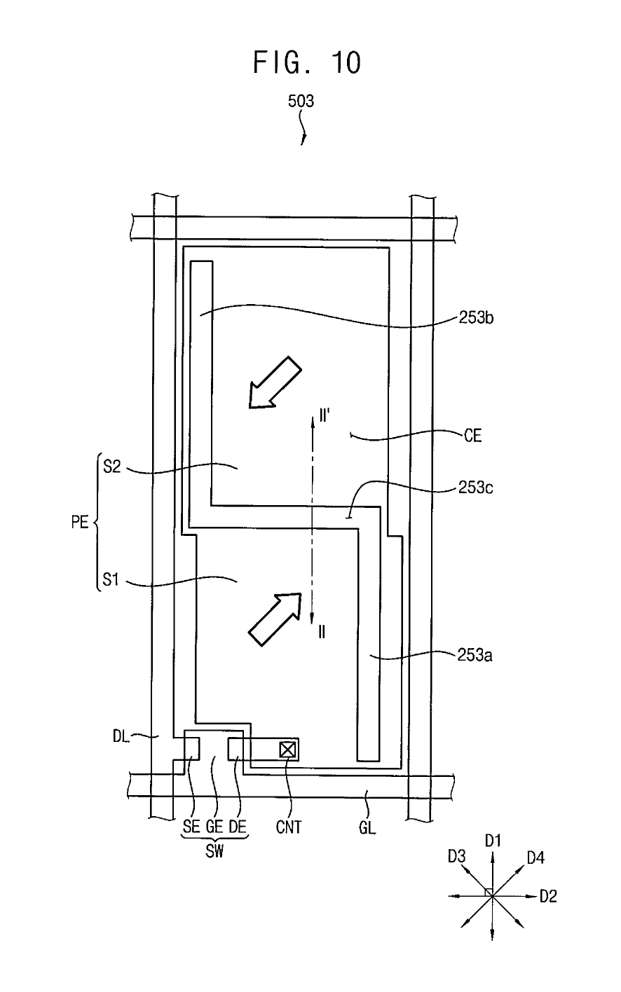

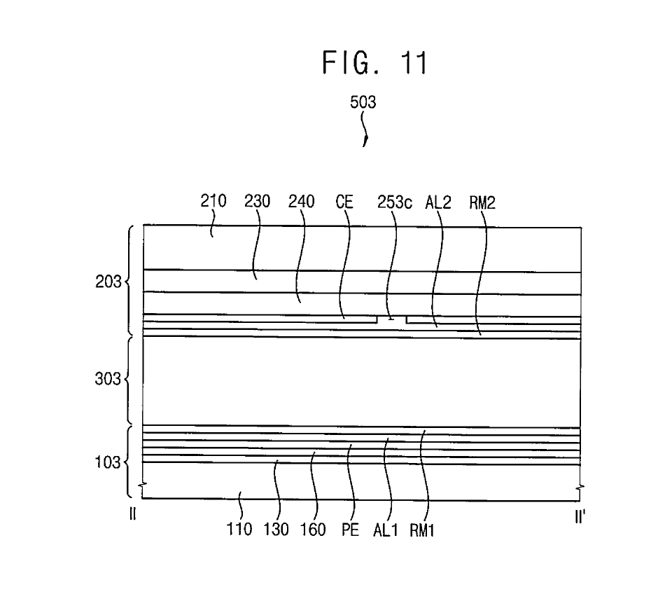

FIG. 10 is a plane view illustrating a LCD panel 503 of a display apparatus according to an exemplary embodiment of the present invention, and FIG. 11 is a cross-sectional view taken along a line II-II′ of FIG. 10.

The display apparatus according to the present exemplary embodiment includes the first and second polarizing plates PL1 and PL2 as illustrated in FIG. 1, the first and second phase delay film RT1 and RT2, and the LCD panel 503 illustrated in FIG. 10 and FIG. 11. In is other words, the display apparatus according to the present exemplary embodiment is substantially identical to the display apparatus 701 illustrated in FIG. 1, except the LCD panel 503. Thus, the display apparatus according to the present exemplary embodiment is described referring to FIG. 1, FIG. 10, and FIG. 11, so that any repetitive detailed explanation concerning the above elements will be omitted.

Referring to FIG. 10 and FIG. 11 with FIG. 1, the LCD panel 503 includes a TFT substrate 103, an opposite substrate 203, and a liquid crystal layer 303. A first phase delay film RT1 is disposed under the TFT substrate 103 and a first polarization plate PL1 is disposed under the phase delay film RT1. Also, a second phase delay film RT2 is disposed on the opposite substrate 203 and the second polarizing plate PL2 is disposed on the second phase delay RT2.

The TFT substrate 103 includes a gate line GL, a data line DL, a thin film transistor SW, a pixel electrode PE, a first alignment film AL1, and a first mesogen hardening layer RM1. The TFT substrate 103 is substantially identical to the TFT substrate 101 described with respect to FIG. 8 and FIG. 9 except the pixel electrode PE, so that any repetitive detailed explanation concerning the above elements will be omitted.

The pixel electrode PE includes the first sub-electrode part S1 and second sub-electrode part S2. The second sub-electrode part S2 is disposed on the first sub-electrode when viewed on a plane, the second sub-electrode being alternately connected to the first sub-electrode part S2.

The opposite substrate 203 includes a shielding pattern (not shown), a second base substrate 210, a color filter 230, an over coating layer 240, a common electrode CE, a second alignment layer AL2, and a second mesogen hardening layer RM2. The opposite substrate 203 is substantially identical to the opposite substrate 201 described with reference to FIG. 8 and FIG. 9 except the common electrode CE, so that any repetitive detailed explanation concerning the above elements will be omitted.

The common electrode CE includes a third opening 253a, a fourth opening 253b and a fifth opening 253c. The third opening 253a is extended in a first direction D1 along a side of the first sub-electrode part S1 to be overlapped with the first sub-electrode part S1. The fourth opening 253b is disposed substantially parallel with the third opening 253a and is extended in the first direction D1 along a side of the second sub-electrode S2 part to be overlapped with the second sub-electrode part S2. The first direction D1 may be substantially identical to the extending direction of the data line DL of the TFT substrate 103. The fifth opening 253c extends substantially perpendicularly to the first direction D1 in the second direction D2 to connect the third and fourth openings 253a and 253b. The second direction D2 is formed an angle about 87 degrees to 100 degrees with respect to the first direction D1.

The liquid crystal molecules of the liquid crystal layer 303 are aligned in a homeotropic vertical direction between the TFT substrate 103 and the opposite substrate 203 to form an angle about 87 degrees to 90 degrees by the first and second alignment films AL1 and AL2 and the first and second mesogen hardening layers RM1 and RM2 when an electric field is not applied to the liquid crystal layer 303. Also, the liquid crystal molecules are aligned in a small angle to a fourth direction D4 which is between the first and second directions D1 and D2, the first and second directions D1 and D2 are formed an angle about 40 degrees to 50 degrees with respect the first polarizing axis 10 of the first polarization plate PL1, when the electric filed is applied to the liquid crystal layer 303 by the first sub-pixel part S1 and the third and fifth openings 253a and 253c.

Also, the liquid crystal molecules are aligned as being inclined by a small angle to is the fourth direction D4 by the second sub-pixel part S2, the fourth and fifth openings 253b and 253c. The direction D4 is the opposite direction of the direction of the inclined direction of the liquid crystal molecules of the first sub-pixel part S1. Thus, the director of the liquid crystal molecules is declined according to the fourth direction D4 when the electric filed is applied to the liquid crystal layer 303.

Thus, a transmitted light may pass through the LCD panel 503 without any effect when the electric field is not applied, however, the LCD panel 503 may polarize the light when the electric field is applied. Thus, the LCD panel 503 may be used to in normally white mode display apparatus including the first and second polarization plates PL1 and PL2, the first and second phase delay films RT1 and RT2, and the liquid crystal display 503. The visibility and contrast ratio of the display apparatus may thus be improved.

The first and second mesogen hardening layers RM1 and RM2 may be formed with the first and second alignment films AL1 and AL2 in a substantially identical method as described above with respect to the exemplary embodiment shown in FIG. 9.

The first and second mesogen hardening layers RM1 and RM2 may be formed by a particular method. The first and second alignment layers AL1 and AL2 may be formed by adding an active mesogen to a composite for manufacturing alignment film. The liquid composite including the liquid crystal molecules may be interposed on the first and second alignment films AL1 and AL2. The light is irradiated into the first and second alignment films AL1 and AL2 which has the liquid composite when an electric field is applied to the liquid crystal layer 303. Another method is that forming the first and second alignment layer AL1 and AL2, using the a composite for manufacturing an alignment film which has a function group having an alignment polymer and is substantially identical to a photo chemical reactor of the is reactive mesogen. Light is irradiated into the liquid composite including the liquid crystal molecules being interposed on the first and second alignment films AL1 and AL2 when the electric field is applied to the liquid crystal layer.

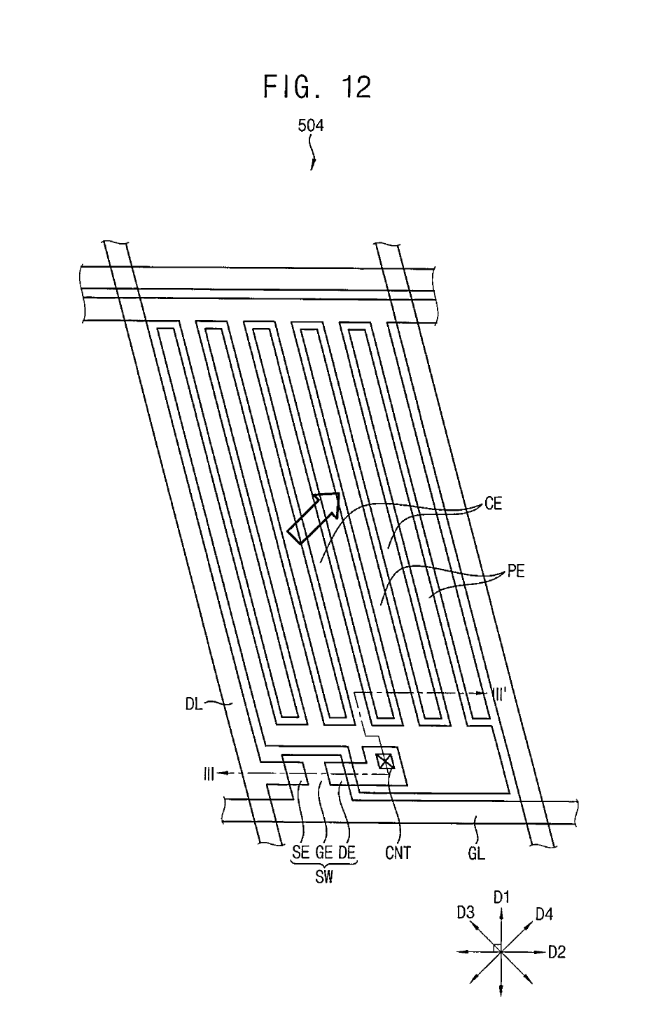

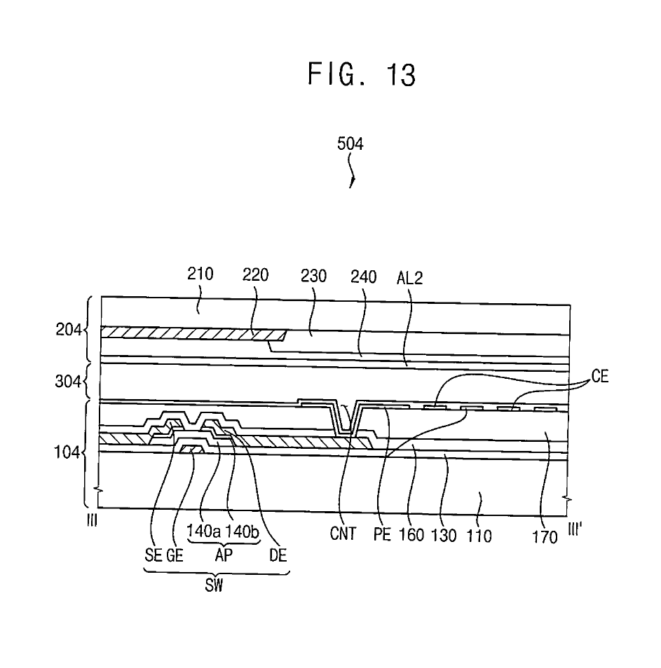

FIG. 12 is a plane view illustrating a LCD panel 504 of a display apparatus according to an exemplary embodiment of the present invention, and FIG. 13 is a cross-sectional view taken along a line III-III′ of FIG. 12.

The display apparatus according to the present exemplary embodiment includes first and second polarizing plates PL1 and PL2, first and second phase delay films RT1 and RT2, and a LCD panel 504 as shown in FIG. 12 and FIG. 13. In other words, the display apparatus according to the present exemplary embodiment is substantially identical to the display apparatus 701 except the LCD panel 504. Thus, the display apparatus according to the present exemplary embodiment is described with reference to FIG. 1, FIG. 12, and FIG. 13, so that any repetitive detailed explanation concerning the above elements will be omitted.

Referring to FIG. 12 and FIG. 13 with respect to the exemplary embodiment shown in FIG. 1, the LCD panel 504 includes a TFT substrate 104, an opposite substrate 204, and a liquid crystal layer 304.

The TFT substrate 104 is disposed on the first phase delay film RT1 and includes a gate line GL, a data line DL, which are disposed on the base substrate 110, a thin film transistor SW which is a switching device, a pixel electrode PE, a common electrode CE, and a first alignment film AL1. Also, the TFT substrate 104 may include a gate insulating layer 130, passivation layer 160, and organic layer 170.

The data line DL is extended in a direction being inclined to a counter-clockwise direction with respect to the first direction D1 of the first polarization axis 10 of the first is polarization plate PL1. The angle may be about 15 degrees. The gate line GL is extended to a second direction D2 which forms an angle about 80 degrees to 100 degrees with respect to the first direction D1. The thin film transistor SW includes a gate electrode GE being connected to the gate line GL, a source electrode SE being connected to the data line DL, a drain electrode DE being separated from the source electrode SE, and an active pattern AP.

The pixel electrode PE includes a plurality of first slit electrodes and is connected to the thin film transistor SW. The first slit electrodes are extended along an extension direction of the data line DL and are spaced apart from each other along the second direction D2. By using connection electrodes of the pixel electrode PE extended along the first direction D1, each other part of the first slit electrodes may be connected. The first connection electrodes may be disposed parallel with the gate line GL.

The common electrode CE includes a plurality of second slit electrodes disposed on an identical plane with the pixel electrode PE. The second slit electrodes are extended in a substantially identical direction with the first slit electrodes and are disposed between or to adjacent the second slit electrodes. The second slit electrodes are extended in the first direction D1 and each of the second slit electrodes may be connected by a second electrode disposed in an opposing direction with the first connection electrode. A second slit electrode disposed on each pixel of the LCD panel 504 may be connected by the second connection electrode.

The first alignment film AL1 is disposed on the pixel electrode PE and the common electrode CE. The first alignment film AL1 may be a horizontal alignment film which aligns the liquid crystal molecules in a homogeneous parallel direction when an electric field is not applied.

The opposite substrate 204 includes a shielding pattern 220 formed on a second is base substrate 210, a color filter 230, an over coating layer 240, and a second alignment layer AL2. The second alignment layer AL2 may be a horizontal alignment film which aligns the liquid crystal molecules in a homogeneous parallel direction.

The liquid crystal molecules are aligned to extend in a direction of the first and second silt electrodes when the electric field is not applied to the liquid crystal layer 304, so that transmitted light passing through the first phase delay film RT1 without any change may be irradiated into the liquid crystal layer 304. The liquid crystal molecules are aligned horizontally to a vertical direction by the first and second silt electrodes, when the electric field is applied to the liquid crystal layer 304. In other words, a horizontal electric field is formed. The direction of the director of the liquid crystal molecules and the first and second direction D1 and D2 are disposed in an alternating arrangement. The direction of the director of the liquid crystal molecules forms an acute angle with respect to the second direction D2 when the electric field is applied. The angle is an acute angle which has about 40 degrees to 50 degrees with respect to the second direction D2. Thus, the light passes through the liquid crystal layer 304, and the liquid crystal layer 304 may polarize the light when the electric field is applied to the liquid crystal layer 304. A direction of the arrow shown in FIG. 12 represents a direction of the director of the liquid crystal molecules when the electric field is applied to the liquid crystal layer 304.

Thus, a transmitted light may pass through the LCD panel 504 without any effect when the electric field is not applied to liquid crystal layer 304. However, the LCD panel 504 may polarize the light when the electric field is applied to liquid crystal layer 304, so that the LCD panel 504 may be used in a normally white mode display apparatus including the first and second polarization plates PL1 and PL2, the first and second phase delay films RT1 and RT2, and the LCD panel 504. The visibility and contrast ratio of the display apparatus thus may be improved.

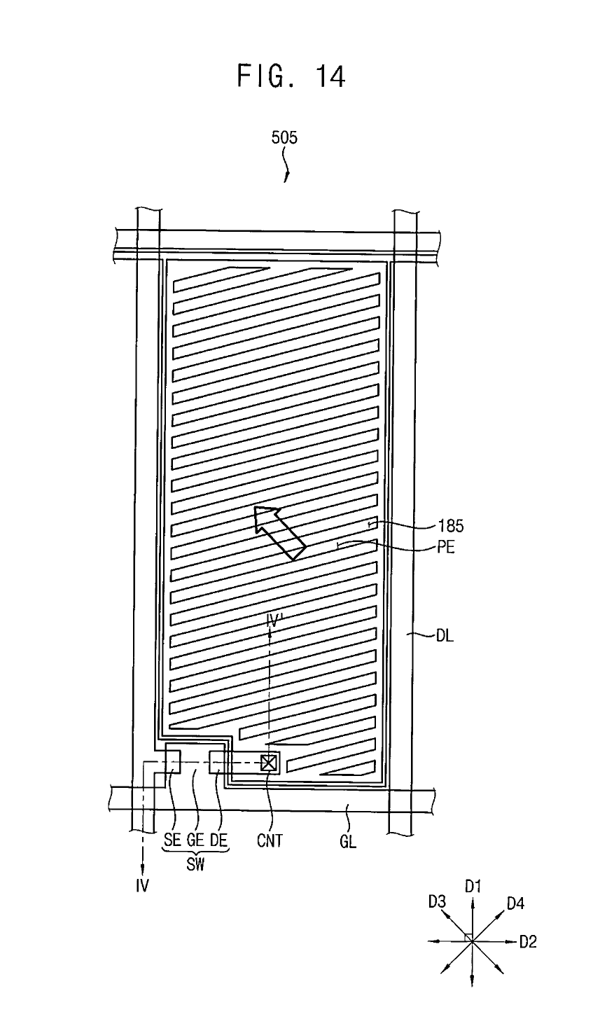

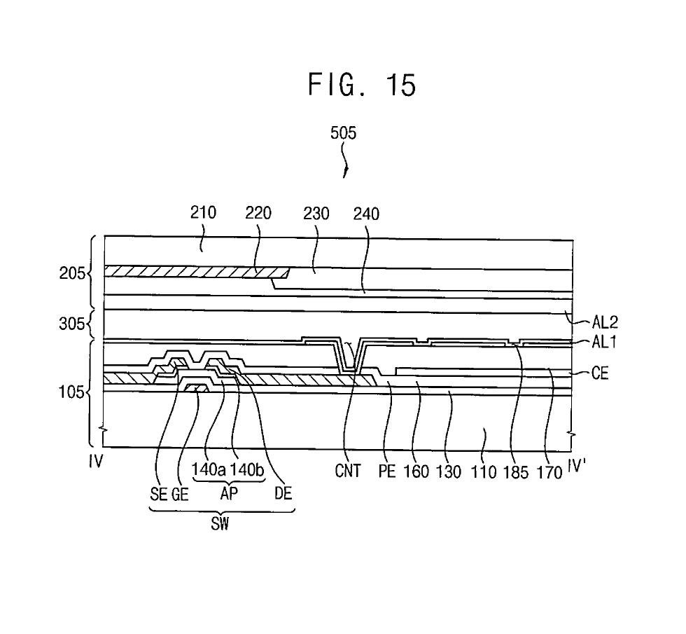

FIG. 14 is a plane view illustrating an LCD panel 505 of a display apparatus according to an exemplary embodiment of the present invention, and FIG. 15 is a cross-sectional view taken along a line IV-IV′ of FIG. 14.

The display apparatus according to the present exemplary embodiment includes first and second polarizing plates PL1 and PL2, first and second phase delay films RT1 and RT2, and a LCD panel 505 similar to as shown in FIG. 12 and FIG. 13. In other words, a display apparatus according to the present exemplary embodiment is substantially identical to the display apparatus 701 except the LCD panel 505. Thus, the display apparatus according to the present exemplary embodiment is described with reference to FIG. 1, FIG. 12, and FIG. 13, so that any repetitive detailed explanation concerning the above elements will be omitted.

Referring to FIG. 14 and FIG. 15 with respect to the exemplary embodiment shown in FIG. 1, the LCD panel 505 includes a TFT substrate 105, an opposite substrate 205, and a liquid crystal layer 305.

The TFT substrate 105 is disposed on the first phase delay film RT1 and includes a gate line GL, a data line DL, which are disposed on the base substrate 110, a thin film transistor SW, which is a switching device, a pixel electrode PE, a common electrode CE, and a first alignment film AL1. Also, the TFT substrate 105 may include a gate insulating layer 130, passivation layer 160, and organic layer 170.

The thin film transistor SW includes a gate electrode GE being connected to the gate line GL, a source electrode SE being connected to the data line DL, a drain electrode DE being separated to the source electrode SE and an active pattern AP. The active pattern AP is is partially overlapped with each of the source electrode SE and the drain electrode DE formed on the gate insulating layer 130 covering the gate electrode GE, and includes the semiconductor layer 140a and an ohmic contact layer 140b formed on the semiconductor layer 140a. The semiconductor layer 140a may include amorphous silicon and an oxidation semiconductor. The passivation layer 160 and the organic layer 170 include a contact hole CNT that covers the thin film transistor SW and the drain electrode DE is exposed partially through the contact hole CNT. The pixel electrode PE is connected with the drain electrode DE through the contact hole CNT.

The data line DL is extended in a first direction D1 of a first polarization axis 10 of the first polarization plate PL1, and the gate line GL is extended in a second direction D2 forming an angle about 80 degrees to 100 degrees with respect to the first direction D1.

The pixel electrode PE includes the plurality of silt electrodes connected to the thin film transistor SW. The slit electrodes are extended in a direction that is inclined by an acute angle with respect to the extending direction of the gate line GL. The acute angle may be about 15 degrees. The silt electrodes are connected to each other. The silt electrodes may be defined by an opening part 185, and the opening part 185 is extended in the direction which is inclined by an acute angle.

The common electrode CE is formed by overlapping with the area that the pixel electrode PE is formed to insulate by the pixel electrode PE and the organic layer 170. The common electrode which is disposed at each whole pixels of the LCD panel 505 is connected to each other. The common electrode CE may be formed a horizontal electric field with the pixel electrode PE.

The first alignment film AL1 is disposed on the pixel electrode PE. The first alignment film AL1 may be a horizontal alignment film. The first alignment film AL1 aligns the is liquid crystal molecules of the liquid crystal layer 305 to a homogenous parallel direction when the electric field is not applied to the liquid crystal layer 305.

The opposite substrate 205 includes a shielding pattern 220 formed on a second base substrate 210, a color filter 230, an over coating layer 240, and a second alignment layer AL2. The second alignment layer AL2 may be a horizontal alignment film that aligns the liquid crystal molecules in a homogeneous parallel direction.

The liquid crystal molecules of the liquid crystal layer 305 are aligned to extend in the direction of the silt electrodes of the pixel electrode PE when the electric field is not applied, so that transmitted light passing through the first phase delay film RT1 without any effect may be irradiated into the liquid crystal layer 305. The liquid crystal molecules are aligned substantially parallel to a vertical direction with respect to the direction of the silt electrodes by the horizontal electric field of the pixel electrode and the common electrode, when the electric field is applied to the liquid crystal layer 305. In other words, the direction of the director of the liquid crystal molecules and the first and second directions D1 and D2 are disposed in an alternating arrangement. The direction of the director of the liquid crystal molecules forms an acute angle with respect to the second direction D2 when the electric field is applied to the liquid crystal layer 305, and the liquid crystal layer 305 may polarize the light when the electric field is applied to the liquid crystal layer 305. A direction of the arrow shown in FIG. 12 represents a direction of the director of the liquid crystal molecules when the electric field is applied to the liquid crystal layer 305.

FIG. 14 and FIG. 15 describe an exemplary embodiment in which the pixel electrode PE includes the silt electrodes, and the common electrode CE is entirely covering the pixel. However, the pixel electrode PE may be formed entirely on the passivation layer, and the is common electrode CE may be formed on the organic layer 170 to include slit electrodes.

A transmitted light may pass through the LCD panel 505 without any change when the electric field is not applied to liquid crystal layer 305. The light may be polarized by passing through the LCD panel 505 when the electric field is applied to liquid crystal layer. Thus, the LCD panel 505 may be used in a normally white mode display apparatus including first and second polarization plates PL1 and PL2, first and second phase delay films RT1 and RT2, and the LCD panel 505. Color reproducibility, visibility, and contrast ratio of the display apparatus may thus be improved.

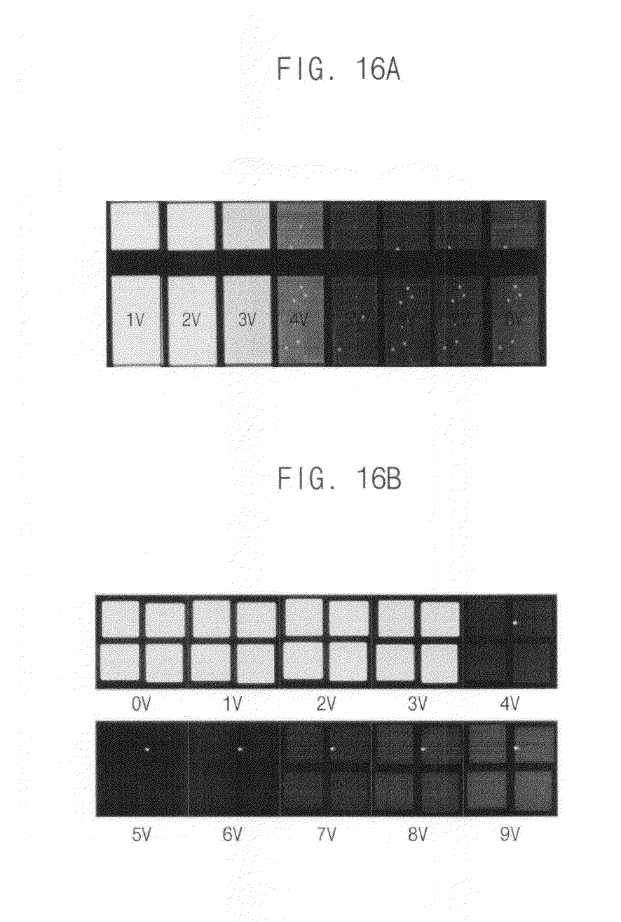

FIGS. 16A and 16B are images illustrating visibility of display panels according to example embodiments of the present invention. FIG. 16A is an image illustrating visibility of a display panel having a wavelength dispersion according to various voltages applied to the pixel electrodes. FIG. 16B is an image illustrating visibility of a display panel without a wavelength dispersion according to various voltages applied to the pixel electrodes.

Referring to FIGS. 16A and 16B, visibility of the display panel without a wavelength dispersion is better than that of the display panel having a wavelength dispersion.

As explained with respect to the exemplary embodiments above, wavelength dispersion may be minimized at in the normally white mode display apparatus. Thus, visibility of an image displayed from the display apparatus may be improved. Furthermore, a phase delay film disposed on a liquid crystal layer may compensate for light passing through the liquid crystal layer to optimize a polarization state of the light passing through the liquid crystal layer. Thus, the phase delay film disposed on the liquid crystal layer may minimize black brightness when a black image is displayed.

For example, the display apparatus may be used as a transparent display apparatus. The distortion of the image may be minimized by the wavelength dispersion in the transparent display apparatus when an electric filed is not applied. An object disposed on an opposite side of the transparent display from the viewer apparatus may be seen through the transparent display apparatus. Thus, the visibility of an image that the transparent display apparatus displays may be improved.

According to an exemplary embodiment of the present invention, wavelength dispersion may be minimized in a normally white mode display apparatus. A phase delay film disposed on a LCD panel in the display apparatus may compensate light passing through the LCD panel, to optimize a polarization state of the light passing through the liquid crystal layer of the LCD panel. Thus, the phase delay film disposed on the LCD panel may minimize black brightness when a black image is displayed and a contrast ratio may be improved in the normally white mode display apparatus.

For example, the display apparatus may be used as a transparent display apparatus. Distortion of an image may be minimized by wavelength dispersion in the transparent display apparatus and distribution of the refractivity may be uniform when an electric field is not applied. An external object disposed on an opposite side of the transparent display apparatus may be seen through the transparent display apparatus. Thus, visibility of an image displayed through the transparent display apparatus may be improved. Also, the transparent display apparatus may be a normally white mode display apparatus. Though a voltage is not applied to the transparent display apparatus, the transparent display apparatus displays a white image which is a light transmission state. Thus, visibility of an external object may not be reduced when a power source for the display apparatus is turned off or blocked by a malfunction.

It will be apparent to those skilled in the art that various modifications and is variation can be made in the present invention without departing from the spirit or scope of the invention. Thus, it is intended that the present invention cover the modifications and variations of this invention provided they come within the scope of the appended claims and their equivalents.

What is claimed is:

1. A display apparatus, comprising:
a first polarization plate comprising a first polarization axis;
a second polarization plate facing the first polarization plate, the second polarization plate comprising a second polarization axis, the second polarization axis forming an angle of about 85 degrees to about 95 degrees with respect to the first polarization axis;
a first phase delay film disposed between the first polarization plate and the second polarization plates, the first phase delay film comprising a third polarization axis forming an angle of about 40 degrees to about 50 degrees with respect to the second polarization axis;
a second phase delay film disposed between the second polarization plate and the first phase delay film, the second phase delay film comprising a fourth polarization axis forming an angle of about −5 degrees to about 5 degrees with respect to the third polarization axis; and
a liquid crystal display panel disposed between the first phase delay film and the second phase delay film, the liquid crystal display panel comprising a fifth polarization axis by an arrangement of liquid crystal molecules in a liquid crystal layer of the liquid crystal display panel is when an electric field is applied thereto, the fifth polarization axis forming an angle of about 80 degrees to about 100 degrees with respect to the fourth polarization axis.

2. The display apparatus of claim 1, wherein each of the first phase delay film and the second phase delay film comprises an optical film configured to delay a phase of light by about λ/4.

3. The display apparatus of claim 2, wherein each of the first phase delay film and the second phase delay film comprises a ratio of a phase delay value Δnd on a surface of the liquid crystal layer to a phase delay value Ro on a surface of each of the first phase delay film and the second phase delay film, and the ratio is constant with respect to a wavelength.

4. The display apparatus of claim 3, wherein each of the first phase delay film and second phase delay film comprises an optical film.

5. The display apparatus of claim 1, wherein the display apparatus is configured to pass an irradiated light into the first polarization plate, the first phase delay film, the liquid crystal display panel, and the second phase delay film, in sequence, and wherein the second polarization plate is configured to absorb the light after passing through the second phase delay film.

6. The display apparatus of claim 5, wherein a phase difference of the light having passed through the first phase delay film and the light having passed through the liquid crystal display panel is about 0 degrees, and
wherein the display apparatus is configured to pass light through the first phase delay film, the liquid crystal display panel, and the second phase delay film, and the second polarization plate, in sequence, when an electric field is not applied to the liquid crystal layer.

7. The display apparatus of claim 1, wherein the light irradiated into the first polarizing plate comprises a natural light, and passes in a direction from the first polarization plate to the second polarization plate.

8. The display apparatus of claim 1, wherein the liquid crystal display panel comprises:
a thin film transistor substrate comprising a first alignment film configured to align the liquid crystal molecules in a homeotropic vertical direction when an electric field is not applied to the liquid crystal layer; and
an opposite substrate facing the thin film transistor substrate, the opposite substrate comprising a second alignment film configured to align the liquid crystal molecules in the homeotropic vertical direction,
wherein the liquid crystal layer is disposed between the thin film transistor substrate and the opposite substrate.

9. The display apparatus of claim 8, wherein each of the first alignment film and the second alignment film comprises a photo-alignment layer, and the photo-alignment layer comprises an alignment direction substantially parallel with the fifth polarization axis.

10. The display apparatus of claim 8, wherein the thin film transistor substrate further comprises a pixel electrode disposed between a first base substrate and the first alignment film, and the pixel electrode comprises a plurality of first openings that are spaced apart from each other, and
wherein the opposite substrate further comprises a common electrode disposed between a second base substrate and the second alignment film, and the common electrode comprises a second opening arranged between the first openings.

11. The display apparatus of claim 8, wherein the thin film transistor substrate further comprises a pixel electrode comprising a slit pattern extended in a direction substantially parallel with the fifth polarization axis, and the opposite substrate further comprises a common electrode arranged on an entire surface of the opposite substrate.

12. The display apparatus of claim 8, wherein the thin film transistor substrate further comprises a pixel electrode comprising:
a first sub-electrode part; and
a second sub-electrode part arranged on the first sub-electrode part, the second sub-electrode part connected to the first sub-electrode part, and
wherein the opposite substrate further comprises a common electrode comprising:
a third opening extending along a first side of the first sub-electrode part, the third opening to be overlapped with the first sub-electrode part;
a fourth opening arranged substantially parallel with the third opening and extending along a second side of the second sub-electrode part, the fourth opening to be overlapped with the second sub-electrode part; and
a fifth opening extending substantially perpendicular to the extending direction of the third opening and the fourth opening, the fifth opening connecting the third opening and the fourth opening.

13. The display apparatus of claim 12, wherein the thin film transistor substrate further comprises a first mesogen hardening layer arranged on the first alignment film, and wherein the opposite substrate further comprises a second mesogen hardening layer arranged on the second alignment film.

14. The display apparatus of claim 1, wherein the liquid crystal display panel further comprises:
a thin film transistor substrate comprising a first alignment film configured to align the liquid crystal molecules in a homogeneous parallel direction; and
an opposite substrate facing the thin film transistor substrate, the opposite substrate comprising a second alignment film configured to align the liquid crystal molecules in the homogeneous parallel direction,
wherein the liquid crystal layer is disposed between the thin film transistor substrate and the opposite substrate.

15. The display apparatus of claim 14, wherein a director of the liquid crystal molecules has a direction substantially parallel with the first polarization axis or the second polarizing axis when an electric field is not applied to the liquid crystal layer.

16. The display apparatus of claim 14, wherein the thin film transistor substrate further comprises:
a pixel electrode comprising a plurality of first slit electrodes, the pixel electrode disposed between a first base substrate and the first alignment film; and
a common electrode comprising a plurality of second slit electrodes, the common electrode comprising the same layer as the pixel electrode, the second slit electrodes being arranged between the first slit electrodes.

17. The display apparatus of claim 14, wherein the thin film transistor substrate further comprises:
a pixel electrode comprising a plurality of slits, the pixel electrode disposed between a first base substrate and the first alignment film; and
a common electrode overlapping with the pixel electrode, the common electrode disposed between the pixel electrode and the first alignment film.

18. A display apparatus, comprising:
a first polarization plate comprising a first polarization axis;
a second polarization plate facing the first polarization plate, the second polarization plate comprising a second polarization axis, the second polarization axis forming a vertical angle with respect to the first polarization axis;
a first phase delay film disposed between the first polarization plate and the second polarization plate, the first phase delay film comprising a third polarization axis forming an angle of about 45 degrees with respect to the second polarization axis;
a second phase delay film disposed between the second polarization plate and the first phase delay film, the second phase delay film comprising a fourth polarization axis forming an angle of about −5 degrees to about 5 degrees with respect to the third polarization axis; and
a liquid crystal display panel disposed between the first phase delay film and the second phase delay film, the liquid crystal display panel comprising a fifth polarization axis by an arrangement of liquid crystal molecules of a liquid crystal layer in the liquid crystal display panel when an electric field is applied thereto, the fifth polarization axis forming a vertical angle with respect to the fourth polarization axis.

19. The display apparatus of claim 18, wherein each of the first phase delay film and the second phase delay film comprises an optical film configured to delay a phase of light by about λ/4.

20. A display apparatus, comprising:
a first polarizer comprising a first polarization axis;
a second polarizer facing the first polarizer, the second polarizer comprising a second polarization axis, the second polarization axis forming an angle of about 90 degrees with respect to the first polarization axis;
a first phase delay element disposed between the first polarizer and the second polarizer, the first phase delay element comprising a third polarization axis forming an angle of about 45 degrees with respect to the second polarization axis;
a second phase delay element disposed between the second polarizer and the first phase delay element, the second phase delay element comprising a fourth polarization axis forming an angle of about 0 degrees with respect to the third polarization axis; and
a liquid crystal display element disposed between the first phase delay element and the second phase delay element, the liquid crystal display element comprising a fifth polarization axis when an electric field is applied thereto, the fifth polarization axis forming an angle of about 90 degrees with respect to the fourth polarization axis.
